(19) United States
(12) Patent Application Publication
(10) Pub. No.: US 2011/0152487 A1
(43) Pub. Date: Jun. 23, 2011

(54) PEROXIDE CURED PARTIALLY FLUORINATED ELASTOMERS

(75) Inventors: Jennifer L. Cook, Brooklyn Park, MN (US); Tatsuo Fukushi, Woodbury, MN (US); Werner M.A. Grootaert, Oakdale, MN (US); Alain Verschuere, Melsele (BE)

(73) Assignee: 3M Innovative Properties Company

(21) Appl. No.: 12/640,068

(22) Filed: Dec. 17, 2009

(51) Int. Cl. C08F 4/36; C08F 4/32

(52) U.S. Cl. 526/232; 526/227; 526/232.3

(57) ABSTRACT

Described herein are partially fluorinated elastomers and methods of curing comprising (i) a fluoroelastomer comprising interpolymerized units derived from (a) at least one hydrogen containing monomer and (b) at least one nitrile containing monomer, and (ii) a curing agent, wherein the curing agent consists essentially of a peroxide and a coagent.

### TECHNICAL FIELD

A curable partially fluorinated elastomeric composition is described, which is cured using nitrile containing cure sites and a peroxide curing agent. Methods of curing and cured articles are also described.

### BACKGROUND

There has been an increasing need for higher temperature elastomers that perform adequately at for example, temperatures of 220° C. to 330° C. Because of the higher bond energy of the C—F bond, perfluoroelastomers (fully fluorinated molecules) traditionally have been used at these extreme temperature conditions. However the cost of perfluoroelastomers can make them undesirable or prohibitive for certain applications and markets.

Partially fluorinated elastomers are typically less expensive than perfluorinated elastomers and because they comprise some fluorine, they can perform adequately in some of the same extreme conditions as the perfluorinated elastomers, e.g., chemical resistance, etc. However, one area where partially fluorinated elastomers do not perform as well as their perfluorinated counterparts is in high temperature sealing applications, that require good compression set resistance at elevated temperatures (e.g higher then 230° C.).

There are three major cure systems known to cure partially fluorinated elastomers: diamines, bisphenols, and peroxides. The peroxide cure systems typically use iodine and bromine cure sites on the fluoropolymer, and sometimes, in the presence of certain silanes, chlorine cure sites may be used. Organic peroxides are used to generate free radicals, which react with a coagent, generating a secondary radical that then subsequently abstracts the iodine, bromine, or chlorine, leaving a free radical on the fluoropolymer chain, which then further react with the coagent to generate a crosslinked network. Peroxide cure systems are traditionally known for their chemical resistance, but lack thermal stability. See, V. Arcella and R. Ferro, “Fluorocarbon Elastomers”, in Modern Fluoropolymers, John Scheirs, editor, John Wiley & Sons Ltd., New York, (2000) p. 77-81-352; “Fluorocarbon Elastomers”, in Kirk-Othmer Encylcopedia of Chemical Technology, 4^{th} ed. John Wiley & Sons Ltd., New York, (1993) v. 8, p. 990-995; and A. Logothetis, “Chemistry of Fluorocarbon Elastomers”, in Progress in Polymer Science, v. 14, p. 251-296 (1989) for more discussion on the curing of fluoroelastomers.

### SUMMARY

There is a desire to identify a curing system for partially fluorinated elastomers such as those fluoroelastomers that are based on vinylidene fluoride (often referred to as “FKM” or by their ASTM D1418-06 designation), which improves the high temperature performance.

In one aspect, the present disclosure provides a curable partially fluorinated elastomeric composition comprising (i) a fluoroelastomer comprising interpolymerized units derived from (a) at least one hydrogen containing monomer and (b) at least one nitrile containing monomer, and (ii) a curing agent, wherein the curing agent consists essentially of a peroxide and a coagent.

In one embodiment, the curable partially fluorinated elastomeric composition is essentially free of metal oxide.

In one embodiment, the peroxide is selected from 2,5-dimethyl-2,5-di(t-butylperoxy)-hexane, dicumyl peroxide, di(2-t-butylperoxyisopropyl)benzene, and combinations thereof.

In one embodiment the at least one nitrile containing monomer is selected from CF₂═CFO(CF₂)₅CN, CF₂═CFOCF₂CF(CF₃)OCF₂CF₂CN, CF₂═CFOCF₂CF(CF₃)OCF₂CF(CF₃)CN, CF₂═CFOCF₂CF₂CF₂OCF(CF₃)CN, CF₂═CFOCF₂(CF₃)OCF₂CF₂CN, and combinations thereof.

In another aspect, a cured article is provided comprising a cured partially fluorinated elastomeric composition comprising (i) a fluoroelastomer comprising interpolymerized units derived from (a) at least one hydrogen containing monomer and (b) at least one nitrile containing monomer, and (ii) a curing agent, wherein the curing agent consists essentially of a peroxide and a coagent.

In another aspect, a method of curing a partially fluorinated elastomeric composition is disclosed comprising: (i) providing a fluoroelastomer comprising interpolymerized units derived from (a) at least one hydrogen containing monomer and (b) at least one nitrile containing monomer, and (ii) curing the partially fluorinated elastomer with a curing agent, wherein the curing agent consists essentially of a peroxide and a coagent.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more;

“and/or” is used to indicate one or both stated cases may occur, for example A and/or B includes, (A and B) and (A or B);

“backbone” refers to the main continuous chain of the polymer;

“crosslinking” refers to connecting two pre-formed polymer chains using chemical bonds or chemical groups;

“cure-site” refers to functional groups, which may participate in crosslinking; and

“interpolymerized” refers to monomers that are polymerized together to form a polymer backbone.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

In the present disclosure it has been found that a partially fluorinated elastomer comprising nitrile containing cure sites may be cured with a peroxide/coagent cure system. The resulting partially fluorinated elastomers show good high temperature resistance and compression set.

The elastomers of the present disclosure are partially fluorinated. As disclosed herein a partially fluorinated elastomer is an amorphous polymer comprising at least one hydrogen and at least one fluorine atom on the backbone of the polymer. The partially fluorinated elastomer of the present disclosure comprises interpolymerized monomer units derived from at least one hydrogen containing monomer and at least one nitrile containing cure-site monomer.

Hydrogen containing monomers include those known in the art. The hydrogen containing monomers may or may not contain fluorine atoms. Exemplary hydrogen containing monomers include: vinylidene fluoride, pentafluoropropylene (e.g., 2-hydropentafluoropropylene), vinyl fluoride, trifluoroethylene, propylene, ethylene, isobutylene, and combinations thereof.

In one embodiment, the partially fluorinated elastomer also comprises interpolymerized units derived from a perfluorinated monomer. Exemplary perfluorinated monomers include: hexafluoropropene, tetrafluoroethylene, perfluoro(alkylvinyl ether), chlorotrifluoroethylene, perfluoromethyl vinyl ether, CF₂═CFOCFCF₂CF₂OCF₃, CF₂═CFOCF₂OCF₂CF₂CF₃, CF₂═CFOCF₂OCF₂CF₃, CF₂═CFOCF₂OCF₃, and combinations thereof.

In one embodiment, the partially fluorinated elastomer comprises interpolymerized units derived from (i) hexafluoropropylene, tetrafluoroethylene, and vinylidene fluoride; (ii) hexafluoropropylene and vinylidene fluoride, (iii) vinylidene fluoride and perfluoromethyl vinyl ether, (iv) vinylidene fluoride, tetrafluoroethylene, and perfluoromethyl vinyl ether, (v) vinylidene fluoride, tetrafluoroethylene, and propylene, (vi) tetrafluoroethylene, and propylene, or (vii) ethylene, tetrafluoroethylene, and perfluoromethyl vinyl ether.

The partially fluorinated elastomer also comprises at least one nitrile containing monomer. The partially fluorinated elastomer must contain a sufficient quantity of nitrile functional groups, which can act as cure sites for crosslinking reactions. Nitrile groups may be introduced by use of a nitrile-containing cure site monomer, i.e., the nitrile groups are introduced into the polymer during polymerization. See for example, U.S. Pat. No. 6,281,296 (MacLachlan et al.), which discloses using nitrile-containing olefins and unsaturated ethers to cure perfluorinated fluoropolymers. However, other methods of introduction are also contemplated by this disclosure.

Examples of monomers comprising nitrile-containing groups useful in preparing fluoropolymers comprising a nitrile-containing cure site include free-radically polymerizable nitriles.

The nitrile containing monomer may be selected from perfluorinated cure site monomers. Useful nitrile-containing cure site monomers include, for example, perfluoro(8-cyano-5-methyl-3,6-dioxa-1-octene); CF₂═CFO(CF₂)_{L}CN wherein L is an integer from 2 to 12; CF₂═CFO(CF₂)ᵤOCF(CF₃)CN wherein u is an integer from 2 to 6; CF₂═CFO[CF₂CF(CF₃)O]_{q}(CF₂O)_{y}CF(CF₃)CN wherein q is an integer from 0 to 4 and y is an integer from 0 to 6; or CF₂═CF[OCF₂CF(CF₃)]ᵣO(CF₂)ₜCN wherein r is 1 or 2, and t is an integer from 1 to 4; and derivatives and combinations of the foregoing.

Exemplary nitrile containing monomer include: CF₂═CFO(CF₂)₅CN, CF₂═CFOCF₂CF(CF₃)OCF₂CF₂CN, CF₂═CFOCF₂CF(CF₃)OCF₂CF(CF₃)CN, CF₂═CFOCF₂CF₂CF₂OCF(CF₃)CN, CF₂═CFOCF₂CF(CF₃)OCF₂CF₂CN; and combinations thereof.

The amount of nitrile-containing cure sites in a side chain position of the fluoroelastomer generally is from about 0.05 to about 5 mole percent or even from 0.1 to 2 mole percent relative to the total polymer. Curing agents are added to the partially fluorinated elastomer gum to cure (or crosslink) the fluoropolymer. In the present disclosure a curing agent consisting essentially of a peroxide and a coagent is used to cure the partially fluorinated elastomer comprising nitrile cure sites.

Presently disclosed peroxide curing agents include organic peroxides. In many cases it is preferred to use a tertiary butyl peroxide having a tertiary carbon atom attached to peroxy oxygen.

Exemplary peroxides include: 2,5-dimethyl-2,5-di(t-butylperoxy)hexane; dicumyl peroxide; di(2-t-butylperoxyisopropyl)benzene; dialkyl peroxide; bis(dialkyl peroxide); 2,5-dimethyl-2,5-di(tertiarybutylperoxy)-3-hexyne; dibenzoyl peroxide; 2,4-dichlorobenzoyl peroxide; tertiarybutyl perbenzoate; α,α′-bis(t-butylperoxy-diisopropylbenzene); t-butyl peroxy isopropylcarbonate, t-butyl peroxy 2-ethylhexyl carbonate, t-amyl peroxy 2-ethylhexyl carbonate, t-hexylperoxy isopropyl carbonate, di[1,3-dimethyl-3-(t-butylperoxy)butyl]carbonate, carbonoperoxoic acid, O,O′-1,3-propanediyl OO,OO′-bis(1,1-dimethylethyl) ester, and combinations thereof.

The amount of peroxide curing agent used generally will be at least 0.1, 0.2, 0.4, 0.6, 0.8, 1, 1.2, or even 1.5; at most 2, 2.25, 2.5, 2.75, 3, 3.5, 4, 4.5, 5, or even 5.5 parts by weight per 100 parts of fluoropolymer.

In peroxide cure systems, it is often desirable to include a coagent. Those skilled in the art are capable of selecting conventional coagents based on desired physical properties. Exemplary coagents include: tri(methyl)allyl isocyanurate (TMAIC), triallyl isocyanurate (TAIC), tri(methyl)allyl cyanurate, poly-triallyl isocyanurate (poly-TAIC), triallyl cyanurate (TAC), xylylene-bis(diallyl isocyanurate) (XBD), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, and combinations thereof. Another useful coagent may be represented by the formula CH₂═CH—R_{f1}—CH═CH₂ wherein R_{f1} may be a perfluoroalkylene of 1 to 8 carbon atoms. Such coagents provide enhanced mechanical strength to the final cured elastomer. They generally are used in amount of at least 0.5, 1, 1.5, 2, 2.5, 3, 4, 4.5, 5, 5.5, or even 6; at most 4, 4.5, 5, 5.5, 6, 7, 8, 9, 10, 10.5, or even 11 parts by weight per 100 parts of the fluorocarbon polymer.

The fluoropolymer compositions can also contain a wide variety of additives of the type normally used in the preparation of elastomeric compositions, such as pigments, fillers (such as carbon black), pore-forming agents, and those known in the art.

Metal oxides are traditionally used in peroxide curing. Exemplary metal oxides include: Ca(OH)₂, CaO, MgO, ZnO, and PbO. In one embodiment, the curable partially fluorinated elastomeric composition is essentially free of metal oxide (i.e., the composition comprises less than 1, 0.5, 0.25, 0.1, or even less than 0.05 parts per 100 parts of the fluoroelastomer). In one embodiment, the curable partially fluorinated elastomeric composition comprises metal oxide. For example, at least 1.5, 2, 4, 5, or even 6 parts per 100 parts of the fluoroelastomer.

In the present curing process, the partially fluorinated elastomer gum, along with the required amounts of peroxide, coagent, and other components, is compounded by conventional means, such as in a two-roll mill, at elevated temperatures. The partially fluorinated elastomer gum is then processed and shaped (for example, in the shape of a hose or hose lining) or molded (for example, in the form of an O-ring). The shaped article can then be heated to cure the gum composition and form a cured elastomeric article.

In one embodiment, the curable partially fluorinated elastomer composition comprises at least 0.1, 0.2, 0.4, 0.5, 1.0 or even 1.5 mole %; at most 3, 4, 5, 6, 7, 8, and even 10 mol % of a nitrile containing cure-site monomer or nitrile containing end-groups relative to the fluoroelastomer.

In one embodiment, the curable partially fluorinated elastomeric composition may comprise bromine, chlorine, and/or iodine cure-sites derived from bromine, chlorine, or iodine cure site monomers or chain transfer agents.

In another embodiment, the curable partially fluorinated elastomeric composition is free of or is essentially free of bromine and/or iodine. As used herein, essentially free of bromine and iodine, means that the partially fluorinated elastomer compositions disclosed herein are primarily cured via a peroxide and nitrile cure-sites, not with bromine or iodine cure sites.

Because the resulting cured partially fluorinated elastomer is characterized by a crosslink structure that is primarily cured though the nitrile cure-sites, this results in a fluoroelastomer with outstanding thermal and hydrolytic stability.

In another embodiment, a dual cure system may be used. For example, the peroxide cure system of the present disclosure may be combined with a bisphenol cure and/or a triazine cure.

The cured fluoroelastomers are particularly useful as seals, gaskets, and molded parts in systems that are exposed to elevated temperatures and/or corrosive materials, such as in automotive, chemical processing, semiconductor, aerospace, and petroleum industry applications, among others. Because the fluoroelastomers may be used in sealing applications, it is important that the elastomers perform well under compression. Compressive sealing is based on the ability of an elastomer to be easily compressed and develop a resultant force that pushes back on the mating surfaces. The ability of a material to maintain this resultant force as a function of time over a range of environmental conditions is important to long term stability. As a result of thermal expansion, stress relaxation, and thermal aging, the initial sealing forces will decay over time. By determining the retained sealing force, elastomeric materials can be evaluated for their sealing force retention under a range of conditions, particularly under high temperature conditions, such as 200° C., 225° C., 250° C., and even 275° C.

As shown in the example section below, the partially fluorinated elastomers of the present disclosure when cured with the peroxide/nitrile cure system, provide compression sets at 200° C. to 270° C. that are lower than their conventionally peroxide cured counterparts. This demonstrates that the partially fluorinated elastomers of the present disclosure are less prone to permanent deformation (e.g. compression set) under compression during thermal aging. Thus, these partially fluorinated elastomers may be used in some applications at temperatures where traditionally perfluorinated elastomers are used, especially where chemical resistance is required in combination with thermal resistance. As a result, material cost can be reduced and these fluoropolymers may be made available to more markets.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; Milwaukee, Wis., or known to those skilled in the art unless otherwise stated or apparent.

These abbreviations are used in the following examples: min=minutes, mol=mole; cm=centimeter, mm=millimeter, ml=milliliter, L=liter, psi=pressure per square inch, MPa=megaPascals, wt.=weight, and FT-IR=Fourier transform infrared spectroscopy.

### Fluoroelastomer A

A 4 liter reactor was charged with 2.250 grams of water, 33.3 grams of 30% aqueous solution of CF₃OCF₂CF₂CF₂OCF₂COONH₄ and 3.0 grams of ammonium persulfate (APS, (NH₄)₂S₂O₈). The fluorinated emulsifier CF₃OCF₂CF₂CF₂OCF₂COONH₄ was prepared as described in U.S. Pat. Publ. No. 2007/0015864. The reactor was evacuated, the vacuum was broken and it was pressurized with nitrogen to 25 psi (0.17 MPa). This vacuum and pressurization was repeated three times. After removing oxygen, the reactor was heated to 71.1° C. (160° F.) and pressurized to 62 psi (0.43 MPa) with a blend of hexafluoropropylene (HFP) and perfluoroethenyloxy hexanenitrile (CF₂═CFO(CF₂)₅CN and referred to as MV5CN). The MV5CN is available from Anles Plus, Saint Petersburg, Russia. To prepare the blend of HFP and CF₂═CFO(CF₂)₅CN, a 1-liter, stainless steel cylinder was evacuated and purged 3 times with N₂. After adding CF₂═CFO(CF₂)₅CN to the cylinder, HFP was added based on the amount of CF₂═CFO(CF₂)₅CN added. The blend was then attached to the reactor and was fed using a blanket of N₂. The blend contained 93.6 wt. % of HFP and 6.4 wt. % of CF₂═CFO(CF₂)₅CN. The reactor was then charged with vinylidene fluoride (VDF) and the above described blend of hexafluoropropylene (HFP) and CF₂═CFO(CF₂)₅CN, bringing reactor pressure to 228 psi (1.57 MPa). Total precharge of VDF and the blend of HFP and CF₂═CFO(CF₂)₅CN was 102 grams, and 151 grams, respectively. The reactor was agitated at 650 rpm (revolutions per minute). As reactor pressure dropped due to monomer consumption in the polymerization reaction, the blend of hexafluoropropylene (HFP) and CF₂═CFO(CF₂)₅CN and VDF were continuously fed to the reactor to maintain the pressure at 228 psi (1.57 MPa). The calculated monomer ratio from the monomer feeds of VDF, HFP and CF₂═CFO(CF₂)₅CN was 77.5, 20.5 and 2.0 by mole percent, respectively. After 7 hours the monomer and blend feeds were discontinued and the reactor was cooled. The resulting dispersion had a solid content of about 30 wt. %. For the coagulation, the same amount of a MgCl₂/deionized water solution was added to the latex. The solution contained 1.25 wt. % MgCl₂.6H₂O. The latex was agitated and coagulated. About 4000 ml of deionized water was added and agitated for 15 minutes to wash the crumb then the wash water was drained off. The crumb was washed four times, using a total of 16,000 ml of warm deionized water and dried at 130° C. for 16 hours. The resulting fluoroelastomer raw gum (Fluoroelastomer A in Table 1) had a Mooney viscosity of 58 with ML (1+10) at 121° C. and the polymer had a characteristic absorption peak of—CN group at 2264 cm⁻¹ by FT-IR.

Mooney viscosity or compound Mooney viscosity was determined in accordance with ASTM D1646-06 TYPE A by a MV 2000 instrument (available from Alpha Technologies, Ohio, USA) using large rotor (ML 1+10) at 121° C. Results are reported in Mooney units.

### Fluoroelastomer B

The polymer was prepared as described under “Fluoroelastomer A” except that 1.1 grams of ammonium persulfate (APS, (NH₄)₂S₂O₈), 8 grams of 50% aqueous solution of potassium phosphate dibasic (K₂HPO₄) and 2.7 grams of 1,4-diiodooctafluorobutane (obtained from SynQuest Lab, Florida, USA) were used as the ingredients for polymerization and the reactor temperature was 80° C. To prepare the blend of hexafluoropropylene (HFP) and 1,4-diiodooctafluorobutane, a 1-liter, stainless steel cylinder was evacuated and purged 3 times with N₂. After adding 1,4-diiodooctafluorobutane to the cylinder, HFP was added based on the amount of 1,4-diiodooctafluorobutane added. The blend was then attached to the reactor and was fed using a blanket of N₂. The blend contained 98.33 wt. % of HFP and 1.67 wt. % of 1,4-diiodooctafluorobutane.

After 4.7 hours the monomer and blend feeds were discontinued and the reactor was cooled. The dispersion was worked up as under “Fluoroelastomer A”. The resulting fluoroelastomer raw gum (Fluoroelastomer B in Table 1) had a Mooney viscosity of 4.8 with ML (1+10) at 121° C. The fluoroelastomer contained 82.1 mol % copolymerized units of VDF and 17.1 mol % HFP. The iodine end groups —CF₂CH₂I was 0.3 mol %. The iodine content by neutron activation analysis (NAA) was 0.45 wt. %.

### Fluoroelastomer C

The polymer was prepared by aqueous emulsion polymerization with 79.9 mole % VDF, 18.9 mole % HFP and 1.2 mole % MV5CN. The resulting fluoroelastomer raw gum (Fluoroelastomer C in Table 1) had a Mooney viscosity of 62.

### Example 1

A fluoroelastomer compound was prepared using a 6-inch two roll mill by compounding Fluoroelastomer A with 30 parts of carbon black (obtained under the trade designation “THERMAX MT”, ASTM N990 from Cancarb, Medicine Hat, Alberta, Canada), 3 parts of zinc oxide (obtained under the trade designation “UPS-1” from Zinc Corporation of America, Monaca, Pa.), 2 parts of 50% active 2,5-dimethyl-2,5-di(t-butylperoxy)-hexane (obtained under the trade designation “VAROX DBPH-50” from R.T.Vanderbilt, Norwalk, Conn.) and 3 parts of triallylisocyanurate (TAIC) coagent (98%, obtained under the trade designation “TAIC” from Nippon Kasei, Japan). The compound formulation is shown in Table 2.

The cure characteristics were measured using an Alpha Technologies Rubber Process Analyzer (Alpha Technologies, Akron, Ohio) using a Moving Die Rheometer mode (MDR, a sealed torsion shear rotorless curemeter) under conditions as described in ASTM D5289-07. The frequency was 100 cycles per minute and the strain was 0.5 degree. The following parameters were recorded:

ML: minimum torque level in unit of in-lb (inch-pound)

MH: maximum torque level in unit of in-lb

Δ torque: difference between maximum torque (MH) and minimum torque (ML)

ts2: minutes to 2 inch-lb rise

t′50: minutes to 50% of Δ torque (50% cure time)

t′90: minutes to 90% of Δ torque (90% cure time)

The compound was press-cured using a 15×15 cm, 2 mm thick mold at 177° C. for 5 minutes. Then the press-cured sheet was post cured at 230° C. for 4 hours. The dumbbells for physical properties were cut from the cured sheets with ASTM Die D. The press-cured and post-cured samples were tested for physical properties in accordance with ASTM D 412-06a. The test results are summarized in Table 3.

The compound was press-cured using a 214 O-ring (AMS AS568) mold at 177° C. for 5 minutes. Then the press-cured O-rings were post cured at 230° C. for 4 hours. The post-cured O-rings were tested for compression set for 70 hours at 200° C., 230° C., 250° C. and 270° C. in accordance with ASTM D 395-03 Method B and ASTM D 1414-94. Results are reported as percentages. The test results are summarized in Table 3.

### Example 2

A fluoroelastomer compound was prepared using a 15.2-cm (6-inch) two roll mill by compounding Fluoroelastomer C as in Example 1, but with components as shown in Table 2. “TAIC DLC-A (72% active)” (commercially available from Harwick Standard Distribution Corp., Akron, Ohio) was used instead of the TAIC (98%) of Example 1.

### Example 3

A fluoroelastomer compound was prepared using a 15.2-cm (6-inch) two roll mill by compounding Fluoroelastomer C as in Example 2, but with ZnO.

### Example 4

A fluoroelastomer compound was prepared using a 15.2-cm (6-inch) two roll mill by compounding Fluoroelastomer C as in Example 3, but with trimethylallyl isocyanate (commercially available under the trade designation “TMAIC” from Nippon Kasei, Japan) instead of TAIC.

### Comparative Example 1

“Fluoroelastomer B” was compounded and tested as in Example 1 and the results are summarized in Tables 1 and 3.

### Comparative Example 2

FC-2260 (commercially available from Dyneon LLC, Oakdale, Minn.) was compounded and tested as in Example 2 and the results are summarized in Table 2.

TABLE 1
Fluoroelastomers

| | Mooney | | | |
|---|---|---|---|---|
| | viscosity | | | halogen |
| | ML1 + 10 | | —CN group | content |
| Polymer | @121° C. | Monomer | by FT-IR | (wt. %) |
| Fluoroelastomer A | 58 | VDF/HFP/ | Yes | NONE |
| | | MV5CN | | |
| Fluoroelastomer B | 4.8 | VDF/HFP | No | 0.45 |
| | | | | iodine |
| Fluoroelastomer C | 62 | VDF/HFP/ | Yes | NONE |
| | | MV5CN | | |
| FC-2260 | 60 | VDF/HFP | No | 0.24 |
| | | | | bromine |

TABLE 2
Compound formulation (phr*)

| Material | Ex 1 | CE 1 | Ex 2 | Ex 3 | Ex 4 | CE 2 |
|---|---|---|---|---|---|---|
| Fluoro- | 100 | — | — | — | — | — |
| elastomer A | | | | | | |
| Fluoro- | — | 100 | — | — | — | — |
| elastomer B | | | | | | |
| Fluoro- | — | — | 100 | 100 | 100 | — |
| elastomer C | | | | | | |
| FC-2260 | — | — | — | — | — | 100 |
| MT N990 | 30 | 30 | 20 | 20 | 20 | 20 |
| DBPH-50 | 2.0 | 2.0 | 2.5 | 2.5 | 2.5 | 2.5 |
| TAIC (98%) | 3.0 | 3.0 | — | — | — | 2.5 |
| TAIC (72%) | — | — | 2.5 | 2.5 | — | — |
| TMAIC | — | — | — | — | 2.5 | — |
| ZnO | 3.0 | 3.0 | — | 5.0 | 5.0 | — |

*phr: parts by weight per one hundred parts by weight of rubber
—: not added

TABLE 3
Compound Properties and Cured Compound Properties

| | Ex 1 | CE 1 | CE 2 |
|---|---|---|---|
| Fluoroelastomer | A | B | FC-2260 |

Cure rheology (12 min@177° C.)

| | | | |
|---|---|---|---|
| ML N-m (in-lb) | 0.44 (3.9) | 0.0 (0.0) | 2.17 |
| MH N-m (in-lb) | 2.38 (21.1) | 1.85 (16.4) | 6.34 |
| ts2 (min) | 0.5 | 0.5 | 1.38 |
| t′50 (min) | 0.8 | 0.7 | 1.41 |
| t′90 (min) | 2.5 | 1.0 | 3.28 |
| Tensile strength at break MPa | 13.48 (1955) | 13.73 (1991) | 11.55 (1677) |
| (psi) | | | |
| Elongation at break (%) | 198 | 311 | 372 |
| 100% Modulus MPa (psi) | 5.72 (830) | 2.41 (349) | 1.93 (280) |
| Shore A Hardness | 68 | 64 | 62 |

Physical Properties (Press cure, 5 min @ 177° C.)

| | | | |
|---|---|---|---|
| Tensile strength at break MPa | 22.63 (3282) | 23.30 (3380) | nm |
| (psi) | | | |
| Elongation at break (%) | 193 | 307 | nm |
| 100% Modulus MPa (psi) | 7.61 (1104) | 2.90 (420) | nm |
| Shore A Hardness | 70 | 67 | nm |

O-ring* compression set for 70 hours at various temperatures

| | | | |
|---|---|---|---|
| 200° C. (%) | 28 | 33 | nm |
| 230° C. (%) | 52 | 65 | 107 |
| 250° C. (%) | 65 | 81 | 112 |
| 270° C. (%) | 73 | 95 | nm |

*Press cured for 5 min@177° C. and post cured for 4 hours@230° C.
nm: not measured

TABLE 4
Compound Properties and Cured Compound Properties

| | Ex 2 | Ex 3 | Ex 4 |
|---|---|---|---|
| Fluoroelastomer | C | C | C |

Cure rheology (12 min@177° C.)

| | | | |
|---|---|---|---|
| ML N-m (in-lb) | 2.48 | 2.73 | 2.37 |
| MH N-m (in-lb) | 10.46 | 11.41 | 8.51 |
| ts2 (min) | 0.63 | 0.59 | 2.72 |
| t′50 (min) | 0.81 | 0.76 | 3.86 |
| t′90 (min) | 1.99 | 1.84 | 8.69 |

Physical Properties (Press cure, 10 min @ 177° C.)

| | | | |
|---|---|---|---|
| Tensile strength at break MPa | 9.467 (1374) | 9.542 (1385) | 8.337 (1210) |
| (psi) | | | |
| Elongation at break (%) | 160 | 15-33 | 163 |
| 100% Modulus MPa (psi) | 4.96 (720) | 1.03 (150) | 1.40 (203) |
| Shore A Hardness | 60 | 61 | 57 |

O-ring* compression set for 70 hours at various temperatures

| | | | |
|---|---|---|---|
| 220° C. (%) | 32 | 43 | 57 |
| 250° C. (%) | 58 | 78 | 83 |

*Press cured for 10 min@177° C. and post cured for 24 hours @ 282° C.

Foreseeable modifications and alterations of this invention will be apparent to those skilled in the art without departing from the scope and spirit of this invention. This invention should not be restricted to the embodiments that are set forth in this application for illustrative purposes.

What is claimed is:

1. A curable partially fluorinated elastomeric composition comprising:
(i) a fluoroelastomer comprising interpolymerized units derived from (a) at least one hydrogen containing monomer and (b) at least one nitrile containing monomer, and (ii) a curing agent, wherein the curing agent consists essentially of a peroxide and a coagent.

2. The curable partially fluorinated elastomeric composition of claim 1, wherein the curable partially fluorinated elastomeric composition is essentially free of metal oxide.

3. The curable partially fluorinated elastomeric composition of claim 1, wherein the curable partially fluorinated elastomeric composition is essentially free of bromine and iodine.

4. The curable partially fluorinated elastomeric composition of claim 1, wherein the curable partially fluorinated elastomeric composition further comprises at least one of bromine, chlorine, and iodine cure-sites.

5. The curable partially fluorinated elastomeric composition of claim 1, wherein the peroxide is selected from 2,5-dimethyl-2,5-di(t-butylperoxy)-hexane, dicumyl peroxide, di(2-t-butylperoxyisopropyl)benzene, and combinations thereof.

6. The curable partially fluorinated elastomeric composition of claim 1, wherein the coagent is selected from triallyl isocyanurate, tri(methyl)allyl isocyanurate, triallyl cyanurate, and combinations thereof.

7. The curable partially fluorinated elastomeric composition of claim 1, wherein the at least one nitrile containing monomer is selected from CF₂═CFO(CF₂)₅CN, CF₂═CFOCF₂CF(CF₃)OCF₂CF₂CN, CF₂═CFOCF₂CF(CF₃)OCF₂CF(CF₃)CN, CF₂═CFOCF₂CF₂CF₂OCF(CF₃)CN, CF₂═CFOCF₂CF(CF₃)OCF₂CF₂CN and combinations thereof.

8. The curable partially fluorinated elastomeric composition of claim 1, wherein the at least one hydrogen containing monomer is selected from vinylidene fluoride, 1H-pentafluoropropylene, propylene, ethylene, and combinations thereof.

9. The curable partially fluorinated elastomeric composition of claim 1, wherein the fluoroelastomer further comprises interpolymerized units derived from a perfluorinated monomer.

10. The curable partially fluorinated elastomeric composition of claim 9, wherein the perfluorinated monomer is selected from chlorotrifluoroethylene, tetrafluoroethylene, perfluoromethyl vinyl ether, hexafluoropropylene, CF₂═CFOCFCF₂CF₂OCF₃, CF₂═CFOCF₂OCF₂CF₂CF₃, CF₂═CFOCF₂OCF₂CF₃, CF₂═CFOCF₂OCF₃, and combinations thereof.

11. The curable partially fluorinated elastomeric composition of claim 1, wherein the fluoroelastomer is derived from (i) hexafluoropropylene, tetrafluoroethylene, and vinylidene fluoride; (ii) hexafluoropropylene and vinylidene fluoride, (iii) vinylidene fluoride and perfluoromethyl vinyl ether, (iv) vinylidene fluoride, tetrafluoroethylene, and perfluoromethyl vinyl ether, (v) vinylidene fluoride, tetrafluoroethylene, and propylene, (vi) tetrafluoroethylene, and propylene, or (vii) ethylene, tetrafluoroethylene, and perfluoromethyl vinyl ether.

12. A cured article comprising the curable partially fluorinated elastomeric composition of claim 1.

13. The cured article of claim 1, wherein the cured article is essentially free of metal oxide.

14. A method of curing a partially fluorinated elastomeric composition comprising: (i) providing a fluoroelastomer comprising interpolymerized units derived from (a) at least one hydrogen containing monomer and (b) at least one nitrile containing monomer, and (ii) curing the partially fluorinated elastomer with a curing agent, wherein the curing agent consists essentially of a peroxide and a coagent.

15. A method of claim 14, wherein the partially fluorinated elastomer is essentially free of metal oxide.

16. The method of claim 14, wherein the curable partially fluorinated elastomeric composition is essentially free of bromine and iodine.

17. The method of claim 14, wherein the peroxide is selected from 2,5-dimethyl-2,5-di(t-butylperoxy)-hexane, dicumyl peroxide, di(2-t-butylperoxyisopropyl)benzene, and combinations thereof.

18. The method of claim 14, wherein the coagent is selected from triallyl isocyanurate, tri(methyl)allyl isocyanurate, triallyl cyanurate, and combinations thereof.

19. The method of claim 14, wherein the at least one nitrile containing monomer is selected from CF₂═CFO(CF₂)₅CN, CF₂═CFOCF₂CF(CF₃)OCF₂CF₂CN, CF₂═CFOCF₂CF(CF₃)OCF₂CF(CF₃)CN, CF₂═CFOCF₂CF₂CF₂OCF (CF₃)CN, CF₂═CFOCF₂CF(CF₃)OCF₂CF₂CN, and combinations thereof.

20. The method of claim 14, wherein the at least one hydrogen containing monomer is selected from vinylidene fluoride, propylene, ethylene, isobutylene, and combinations thereof.
